(19) United States
(12) Patent Application Publication
(10) Pub. No.: US 2017/0154620 A1
(43) Pub. Date: Jun. 1, 2017

(54) MICROPHONE ASSEMBLY COMPRISING A PHONEME RECOGNIZER

(71) Applicant: Knowles Electronics, LLC, Itasca, IL (US)

(72) Inventors: Kim Spetzler Berthelsen, Koge (DK); Kasper Strange, Copenhagen O (DK); Henrik Thomsen, Holte (DK)

(21) Appl. No.: 14/955,599

(22) Filed: Dec. 1, 2015

(51) Int. Cl. G10L 15/16; G10L 15/02; G06F 3/16; G10L 15/28

(52) U.S. Cl. CPC G10L 15/16; G10L 15/28; G10L 15/02; G06F 3/162; G10L 2015/025; G10L 2015/088

(57) ABSTRACT

The present invention relates to a microphone assembly comprising a phoneme recognizer. The phoneme recognizer comprises an artificial neural network (ANN) comprising at least one phoneme expect pattern and a digital processor configured to repeatedly applying one or more sets of frequency components derived from a digital filter bank to respective inputs of an artificial neural network. The artificial neural network is configured to detect and indicate a match between the at least one phoneme expect pattern and the one or more sets of frequency components.

### FIELD OF THE INVENTION

The present invention relates to a microphone assembly comprising a phoneme recognizer. The phoneme recognizer comprises an artificial neural network (ANN) comprising at least one phoneme expect pattern and a digital processor configured to repeatedly applying one or more sets of frequency components derived from a digital filter bank to respective inputs of an artificial neural network. The artificial neural network is configured to detect and indicate a match between the at least one phoneme expect pattern and the one or more sets of frequency components.

### BACKGROUND OF THE INVENTION

Portable communication and computing devices such as smartphones, mobile phones, tablets etc. are compact devices which are powered from rechargeable battery sources. The compact dimensions and battery source both put severe constraints on the maximum acceptable dimensions and power consumption of microphones and microphone amplification circuit utilized in such portable communication devices.

Voice activity detection (VAD) approaches and acoustic activity detection (AAD) approaches are important components of speech recognition software and hardware of such portable communication devices. For example, speech recognition applications running on an application or host processor, e.g. a microprocessor, of the portable communication device, may constantly scan the audio signal generated by a microphone searching for voice activity, usually, with an MIPS intensive voice activity recognition algorithm. Since the voice activity algorithm is constantly running on the host processor, the power used in this voice detection approach is significant. Microphones disposed in portable communication devices such as cellular phones often have a standardized interface to the host processor to ensure compatibility with this interface of the host processor.

In order to enable a voice recognition feature at all times, the power consumption of the overall solution must be small enough to have minimal impact on the total battery life of the portable communication device. As mentioned, this has not occurred with existing devices.

Because of the above-mentioned problems, some user dissatisfaction with previous approaches has occurred. There is a need for microphone assemblies comprising a phoneme recognizer which in addition to recognizing voice activity of the incoming voice or speech signal is capable of recognizing a specific phoneme or a specific sequence of phonemes representing a key word or key phrase.

### SUMMARY OF THE INVENTION

A first aspect of the invention relates to a microphone assembly comprising a transducer element configured to convert sound into a microphone signal and a housing supporting the transducer element and a processing circuit. The processing circuit comprising:
an analog-to-digital converter configured to receive, sample and quantize the microphone signal to generate a multibit or single-bit digital signal;
a phoneme recognizer comprising:
a digital filterbank comprising a plurality of adjacent frequency bands and being configured to divide successive time frames of the multibit or single-bit digital signal into corresponding sets of frequency components;
an artificial neural network (ANN) comprising at least one phoneme expect pattern, a digital processor configured to repeatedly applying the one or more sets of frequency components derived from the digital filter bank to respective inputs of an artificial neural network,
where the artificial neural network is further configured to comparing the at least one phoneme expect pattern with the one or more sets of frequency components to detect and indicate a match between the at least one phoneme expect pattern and the one or more sets of frequency components.

The transducer element may comprise a capacitive microphone for example comprising a micro-electromechanical (MEMS) transducer element. The microphone assembly may be shaped and sized to fit into portable audio and communication devices such as smartphones, tablets and mobile phones etc. The transducer element may be responsive to both impinging audible sound.

The artificial neural network may comprise a plurality of input memory cells such as RAM, registers, FFs, etc., one or more output neurons and a plurality of internal weights disposed in-between the plurality of input memory cells and each of the one or more output neurons. The plurality of internal weights are configured or trained for representing the at least one phoneme expect pattern by a network training session. Likewise, respective connections between the plurality of internal weights and the one or more output neurons are determined during the network training session to define phoneme configuration data for the ANN representing the at least one phoneme expect pattern as discussed in further detail below with reference to the appended drawings.

The digital processor may comprise a state machine and/or a software programmable microprocessor such as a digital signal processor (DSP).

A second aspect of the invention relates to a method of detecting at least one phoneme of a key word or key phrase in a microphone assembly. The method at least comprising:
a) converting incoming sound on the microphone assembly into a corresponding microphone signal;
b) sampling and quantizing the microphone signal to generate a multibit or single-bit digital signal representative of the microphone signal;
c) dividing successive time frames of the multibit or single-bit digital signal into corresponding sets of frequency components through a plurality of frequency bands of a digital filter bank;
d) loading configuration data of at least one phoneme expect pattern into the artificial neural network;
e) applying one or more sets of the frequency components generated by the digital filter bank to inputs of the artificial neural network to detect a match;
f) indicating the match between the at least one phoneme expect pattern and the one or more sets of frequency components at an output of the artificial neural network.

A third aspect of the invention relates to a semiconductor die comprising the processing circuit according to any of the above-described embodiments thereof. The processing circuit may comprise a CMOS semiconductor die. The processing circuit 105 may be shaped and sized for integration into a miniature MEMS microphone housing or package.

A fourth aspect of the invention relates to a portable communication device comprising a transducer assembly according to any of the above-described embodiments thereof. The portable communication device may comprise an application processor, e.g. a microprocessor such as a Digital Signal Processor. The application processor may comprise a data communication interface compliant with, and connected to, an externally accessible command and control interface of the microphone assembly. The data communication interface may comprise an industry standard data interface such as I²C, USB, UART, Soundwire or SPI. Various types of configuration data of the processing circuit for example for programming or adapting the artificial neural network and/or the digital filter bank may be transmitted from the application processor to the microphone assembly as discussed in further detail below with reference to the appended drawings.

### BRIEF DESCRIPTION OF THE DRAWINGS

Embodiments of the invention are described in more detail below in connection with the appended drawings in which:

FIG. 1 shows a schematic block diagram of a microphone assembly according to various embodiments of the present invention,

FIG. 2 shows a schematic diagram of a key word recognizer of a processing circuit of the microphone assembly according to various embodiments of the present invention,

FIG. 3 shows a block diagram of a digital filter bank according to various embodiments of the present invention;

FIG. 4 illustrates schematically one embodiment of a key word recognizer based on an artificial neural network (ANN);

FIG. 5 shows two different spectrograms of the key phrase ‘OK Google’ obtained by different digital filter banks on a frequency scale spanning from 0 to 8 kHz;

FIG. 6 shows a schematic block diagram of a state machine of the key word recognizer; and

FIG. 7 shows schematic block diagrams of a first embodiment and a second embodiment of a FIFO buffer of the processing circuit.

The skilled artisans will appreciate that elements in the appended figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DESCRIPTION OF PREFERRED EMBODIMENTS

Approaches, microphone assemblies and methodologies are described herein that recognize a particular phoneme and/or recognize a predetermined sequence of phonemes representing a key word or key phrase using a phoneme recognizer. The phoneme recognizer may comprise an artificial neural network (ANN) and a digital filter bank that both can be individually programmable or configurable via an externally accessible command and control interface of the microphone assembly.

As used herein, a “phoneme” is an abstraction of a set of equivalent speech sounds or “phones”. In some embodiments, the microphone assembly detects a particular key word or key phrase by detecting the corresponding sequence of phonemes representing the key word or key phrase. The present microphone assembly may form part of an “always on” speech recognition system integrated in a portable communication device. The present microphone assembly may reduce system power consumption by robustly triggering on the key word or key phrase in a wide range of ambient acoustic interferences and thereby minimize false trigger events caused by the detection of isolated phonemes uttered in an incorrect sequence. In some exemplary embodiments of the present approaches, microphone assemblies and methodologies may be tuned or adapted to different key words or key phrases and also in turn tuned to a particular user through configurable parameters as discussed in further detail below. These parameters may be loaded into suitable memory cells of the microphone assembly on request via the configuration data discussed above, for example, using the previously mentioned command and control interface. The latter may comprise a standardized data communication interface such as I²C, UART and SPI.

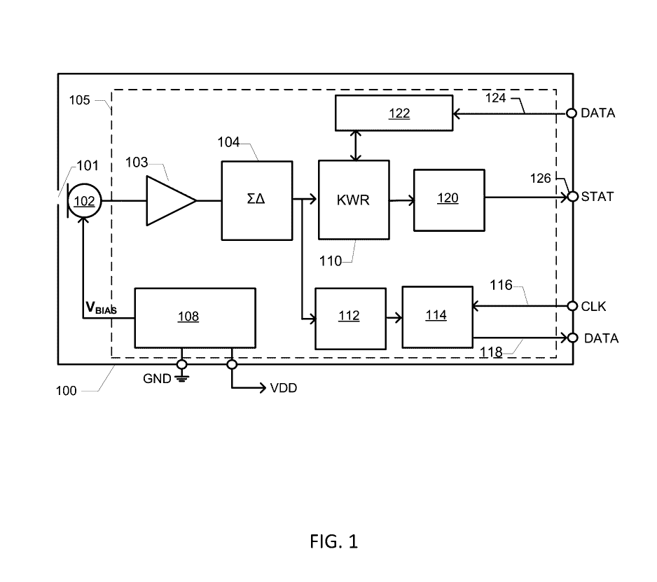

FIG. 1 shows an exemplary embodiment of a microphone assembly or system 100 in accordance with the invention. The microphone assembly 100 comprises a transducer element 102 (e.g. a microelectromechanical system (MEMS) transducer with a diaphragm and back plate) configured to convert incoming sound into a corresponding microphone signal. The transducer element 102 may for example comprise a miniature condenser microphone. A microphone signal generated by the transducer element 102 may be electrically coupled to a processing circuit 105 via bonding wires and/or pads. The microphone assembly 100 may comprise a housing (not shown) supporting, enclosing and protecting the transducer element 102 and the processing circuit 105 of the assembly 100. The housing may comprise a sound inlet or sound port 101 conveying sound waves to the transducer element 102. The processing circuit 105 may comprise a CMOS semiconductor die. The processing circuit 105 may be shaped and sized for integration into a miniature MEMS microphone housing or package. The processing circuit 105 comprises a preamplifier 103 having a signal input coupled to the output of the transducer element 102, for example through a DC blocking or ac coupling capacitor, for receipt of the microphone signal produced by the transducer element 102. The output of the preamplifier 103 supplies an amplified and/or buffered microphone signal to an analog-to-digital converter 104 producing a multibit or single-bit digital signal representative to the microphone signal. The analog-to-digital converter 104 may comprise a sigma-delta converter (ΣΔ) coupled to a decimation filter. The decimation filter may convert a PDM signal generated by the sigma-delta converter into a pulse code modulation (PCM) signal or multi-bit digital signal filtered to eliminate aliasing noise and decimated to an appropriate sampling frequency to maintain a bandwidth of interest, e.g. a sampling frequency between 8 and 32 kHz such as about 16 kHz. The skilled person will understand that the preamplifier 103 is optional or may be integrated with the analog-to-digital converter 104 in other embodiments of the invention.

The processing circuit 105 further comprises a power supply 108, the specialized key word or key phrase recognizer (KWR) 110, a buffer 112, a PDM or PCM interface 114, a clock line 116, a data line 118, a status control module 120, and a command/control interface 122 configured for receiving commands or control signals 124 transmitted from an external application processor of the portable communication device. The structure, features and functionality of the key word recognizer (KWR) 110 is discussed in further detail below. The buffer 112 is configured to temporarily store audio samples of the multi-bit digital signal generated by the analog-to-digital converter 104. The buffer 112 may comprise a FIFO buffer configured to temporarily store a time segment of audio samples corresponding to 100 ms to 1000 ms of the microphone signal. The key word recognizer (KWR) 110 may repeatedly read one or more successive time frames from the buffer 112 and process these to detect the key word or phrase as discussed below in more detail.

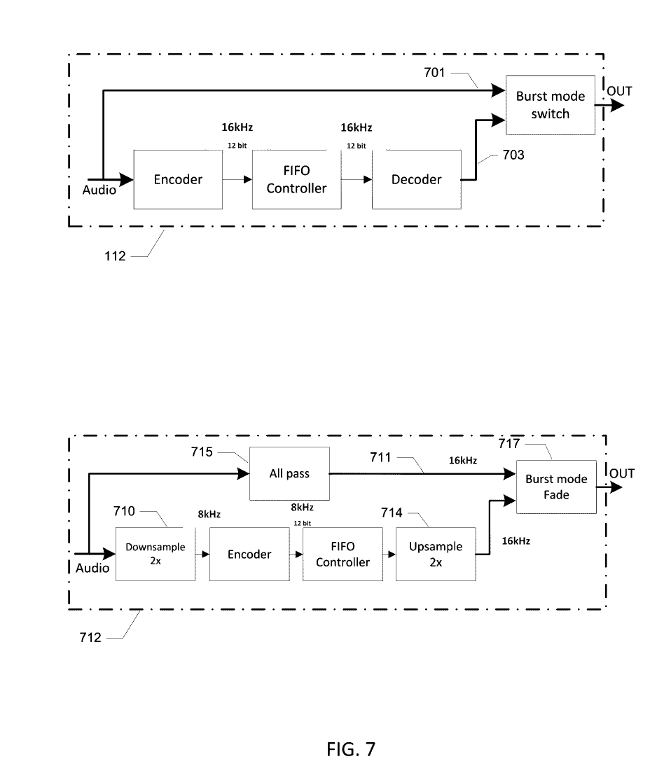

The clock line 116 of the PDM or PCM interface 114 receives an external clock signal from an external processing device, such as the host processor discussed above, to the microphone assembly 100. In one aspect, the external clock signal on the clock line 116 is supplied in response to detection of the key word or phrase. The data line 118 is used to transmit the segment of the multi-bit digital signal (i.e. audio samples) stored in the buffer 112 to the host processor—for example encoded as a PCM signal or PCM data stream. The number of audio samples stored in the buffer may correspond to a time period or duration of the microphone signal between 100 ms and 1 second such as between 250 ms and 800 ms. The skilled person will understand that a large storage capacity of the buffer 112 for storage of a large number of audio samples occupies a large memory area on a semiconductor chip on which electronic components and circuits of the microphone assembly is integrated. In one aspect of the invention, the buffer 112 comprises a downsampler reducing the sampling frequency of incoming audio data stream from a first sampling frequency to a second, and lower, sampling frequency. In this manner, the memory area of the buffer 112 is reduced for a given time period of the microphone signal. The first sampling frequency may for example be 16 kHz and the second sampling frequency 8 kHz. This embodiment of the buffer 112 is discussed in further detail below with reference to FIG. 7.

The status control module 120 signals, flags or indicates the detection of the key word or key phrase in the microphone signal to the host processor through a separate and externally accessible pad or terminal 126 of the microphone assembly. The externally accessible pad or terminal 126 may for example be mounted on a certain portion or component of the housing of the assembly. The status control module 120 may be configured to flag the detection of the key word in numerous ways for example by a logic state transition or logic level shift of the associated pad or terminal 126. The host processor may be connected to the externally accessible pad 126 via a suitable input port for reading the status signalled by the pad 126. The input port of the host processor may comprise an interrupt port such that the key word flag will trigger an interrupt routine executing on the host processor and awaking the latter from a sleep-mode or low-power mode of operation. In one embodiment, the status control module 120 outputs a logic “1” or “high” in response to the detection of the key word on the pad 126. The skilled person will understand that other embodiments of the microphone assembly may be configured to signal or flag the detection of the key word or key phrase in the microphone signal to the host processor through the command/control interface 122 discussed below. In the latter embodiment, the key word recognizer 110 may be coupled to the command/control interface 122 such that the latter generates and transmits a specific data message to the host processor indicating a key word detection.

The command/control interface 122 receives data commands 124 from the host processor and may additionally transmit data commands to the host processor in some embodiments as discussed above. The command/control interface 122 may include a separate clock line that clocks data on a data line of the interface. The command/control interface 122 may comprise a standardized data communication interface according to e.g. 120, USB, UART or SPI. The microphone assembly 100 may receive various types of configuration data transmitted by the host processor. The configuration data may comprise data concerning a configuration and internal weight settings of an artificial neural network (ANN) per phoneme of the key phrase of the key word recognizer 110. The configuration data may additionally or alternatively comprise data concerning characteristics of a digital filter bank of the key word recognizer 110 as discussed in further detail below.

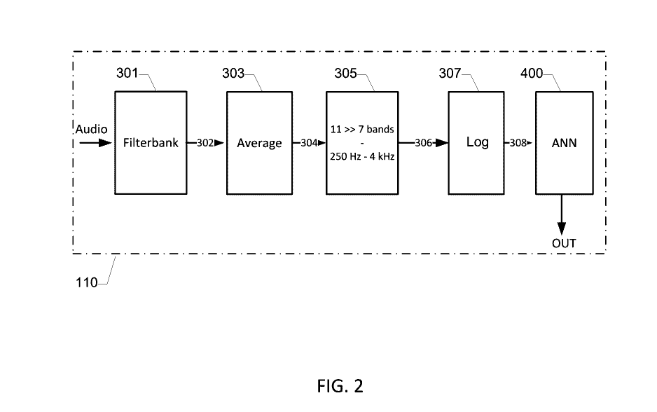

FIG. 2 shows a schematic diagram of a first embodiment of the key word recognizer 110 of the microphone assembly 100. The key word recognizer 110 comprises a digital filterbank 301 which receives the multi-bit/PCM digital signal (i.e. audio samples) outputted by the analog-to-digital converter 104 (please refer to FIG. 1). The digital filterbank 301 is configured to divide successive time frames of the multibit digital signal into a plurality of adjacent frequency bands, and hence, generate a corresponding set of frequency components for each time frame of the multi-bit/PCM digital signal. The multibit digital signal applied at the Audio input may have a sample rate of 16 kHz and therefore a bandwidth (BW) of 8 kHz.

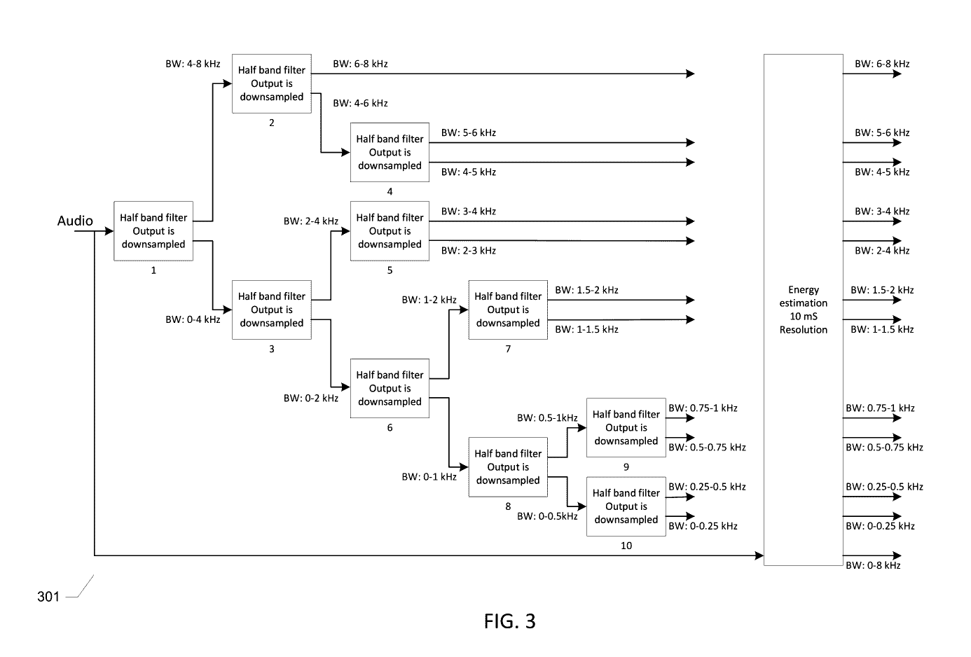

The skilled person will understand that numerous different types of digital filter banks may be used to divide or split the multi-bit/PCM digital signal into the frequency components. In some embodiments, the digital filterbank 301 may comprise a FFT based filter dividing the multibit digital signal into a certain number of linearly spaced frequency bands. In other embodiments, the digital filterbank 301 may comprise a set of adjacent bandpass filters dividing the multibit digital signal into a certain number of logarithmically spaced frequency bands. An exemplary embodiment of the digital filterbank 301 is depicted on FIG. 3. This digital filterbank 301 comprises 11 semi/quasi-logarithmically spaced frequency bands distributed across the frequency range 0-8 kHz. An upper bandpass filter has a bandwidth of approximately 2 kHz with a passband extending from 6-8 kHz and an adjacent bandpass filter has a passband extending between 5-6 kHz as indicated on FIG. 3. The frequency bands are generated by a plurality of so-called half-band filters providing power efficient frequency splitting. A number of useful configurable or programmable digital filter banks, such as QMF half band filter banks, for application in the present invention are disclosed in the applicants' co-pending patent application U.S. No. 62/245,028 filed on 22 Oct. 2015 hereby incorporated by reference in its entirety. The 11 frequency components generated by the digital filterbank 301 is outputted by the schematically illustrated bus 302 and applied to an average function or circuit 303. The average function or circuit 303 is configured to generate respective average energy or power estimates 304 of the 11 frequency components with the 11 frequency bands. The averaging time applied by the average function or circuit 303 in each of the 11 frequency bands may lie between 5 ms and 20 ms such as about 10 ms which in turn may correspond to the length of each time frame of the multibit digital signal representing the incoming microphone signal. Hence, updated power/energy estimates are outputted by the average function or circuit 303 with a frequency between 50 and 200 Hz such as 100 Hz. Following the averaging function, the number of frequency bands for further processing in the KWR 110 may be reduced from an initial number of bands, e.g. 11 bands in the present embodiment, to a smaller number of frequency bands such as 7 frequency bands by a skipping function of circuit 305. The residual 7 frequency bands may preserve a sufficient bandwidth of the speech frequency range of the incoming speech or voice signal to recognize the key word or phrase in question. The reduced number of frequency bands may for example be generated by skipping bands comprising frequency components below 250 Hz and above 4 kHz. The reduced number of frequency bands serves to lower the power consumption of the KWR 110 because of an associated decrease of computational operations, in particular multiplications, which generally are power hungry. The power/energy estimates per frequency band 306 outputted by the skipping function of circuit 305 are applied to a normalizer 307. The normalizer 307 may apply a level compressing function, e.g. a log₂ function, to each of the seven power/energy estimates to compensate or reduce time varying levels fluctuations of the incoming microphone signal. The normalizer 307 may subsequently normalize each time frame of the successive time frames of the multibit digital signal (representing the microphone signal). In this manner, the outputs 308 of the normalizer 307 produce seven normalized power/energy estimates of the selected frequency components of the bandpass filters of the digital filter bank 301 per time frame of the multi-bit digital signal. The seven normalized power/energy estimates 308 are applied to the inputs of the KWR 110 together with several sets of normalized power/energy estimates generated by one or more previous time frames of the multi-bit digital signal as discussed below.

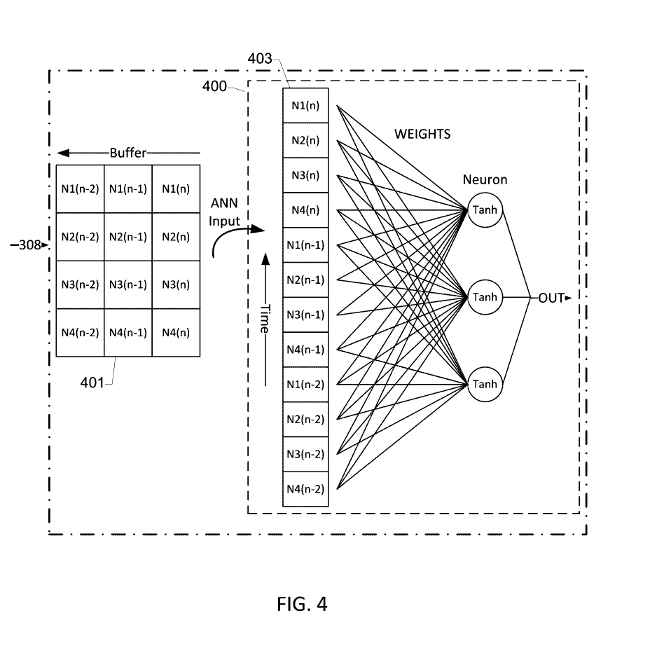

FIG. 4 illustrates schematically one embodiment of the key word recognizer 110 based on an artificial neural network (ANN) 400. The artificial neural network 400 comprises, after appropriate training, a sequence of phoneme expect patterns embedded in internal weights and weight-to-neuron connections for each phoneme of the sequence of phonemes representing the key word or key phrase. Each of the neurons may comprise a hyperbolic tangent function (tan h). The sequence of phoneme expect patterns is modelling the predetermined sequence of phonemes representing the key word or key phrase which the network is desired to recognize. The configuration data associated with the phoneme expect patterns may be derived through feature extraction techniques using a sufficient set of training examples of the key word or phrase. The key words or phrases utilized during the training session are applied to the input of a test filter bank similar to the digital filter bank 301 of the key word recognizer 110. Thereafter, the one or more sets of frequency components are derived from outputs of the test filter bank and applied to respective inputs of the artificial neural network to derive the individual phoneme expect patterns of the predetermined sequence of phoneme expect patterns. The artificial neural network (ANN) 400 may comprise less than 500 internal weights in an initial state—for example between 308 and 500 weights. One exemplary ANN embodiment comprises 42 input memory cells and 7 output neurons leading to 43*7+7=308 internal weights in the initial state. The 42 input memory cells are holding 6 time frames of the digital signal where each time frame comprises a set of 7 frequency components. The training of the ANN 400 may comprise pruning the network in respect of each phoneme of the predetermined sequence of phonemes representing the key phrase/word to reduce the number of internal weights to less than 128 such as between 30 and 60 internal weights. Hence, the number of internal weights of the pruned or trained ANN 400 is typically not constant, but varies depending on characteristics of the individual phonemes of the key phrase. The number of internal weights, values of the internal weights and the respective connections between the internal weights and the neurons for each of the phonemes are recorded or stored as phoneme configuration data.

The artificial neural network 400 may comprise 10 or less neurons in some embodiments. These ANN specifications provide a compact artificial neural network 400 operating with relatively small power consumption and using a relatively small amount of hardware resources, such as memory cells, making the artificial neural network 400 suitable for integration in the present microphone assemblies. The training of the artificial neural network 400 may be carried out by a commercially available software package such as the Neural Network Toolbox™ available from The MathWorks, Inc. After the training of the artificial neural network 400, the respective phoneme configuration data may be downloaded to the key word recognizer 110 via the command/control interface 122 as respective phoneme expect patterns of the predetermined sequence of phoneme expect patterns. The key word recognizer 110 may therefore comprise a programmable key word or key phrase feature where the sequence of phoneme expect patterns is stored as configuration data in rewriteable memory cells of the artificial neural network 400 such as flash memory, EEPROM, RAM, register files or flip-flops. The key word or key phrase may be programmed into the artificial neural network 400 via data commands comprising the phoneme configuration data. The key word recognizer may receive these phoneme configuration data through the previously discussed command and control interface 122 (please refer to FIG. 1). These data commands may be generated by the host processor of the portable communication device or by any suitable external computing device with a compatible data communication interface. According to one embodiment, the host processor of the portable communication device is configured to customize the artificial neural network 400 to the key word or phrase in question based on the end-user's own voice. According to the latter embodiment, the host processor of the portable communication device may execute a customized training session of the artificial neural network 400. The user pronounces the key word or key phrase one or more times. A network training algorithm executed on the host processor identifies the first phoneme of the key word or phrase and trains the artificial neural network 400 to recognize the first phoneme. This training may proceed as described above with pruning of the network to reduce the number of weights and selecting a maximum number of neurons. This process may be repeated for each of the phonemes of the key word or phrase to derive the corresponding phoneme expect pattern. The host processor thereafter transmits the determined configuration data of the network including the internal weights and connections in respect of each phoneme expect pattern of the sequence of phoneme expect patterns to the key word recognizer 110 of the microphone assembly via the command/control interface 122. Hence, the sequence of phoneme expect patterns is obtained via specific training to the end-user's own voice thus incorporating the end-users vocal characteristics in the manner the key word or key phrase is uttered.

The sequence of phoneme expect patterns forming the key word or key phrase may alternatively be programmed into the artificial neural network 400 in a fixed or permanent manner for example as a metal layer of a semiconductor mask of the processing circuit 105.

In the following exemplary embodiments of the artificial neural network 400, the key word/phrase to be recognized is ‘OK Google’, but the skilled person will understand that the artificial neural network 400 may be trained to recognize appropriate phoneme expect patterns of numerous alternative key words or phrases using the techniques discussed above.

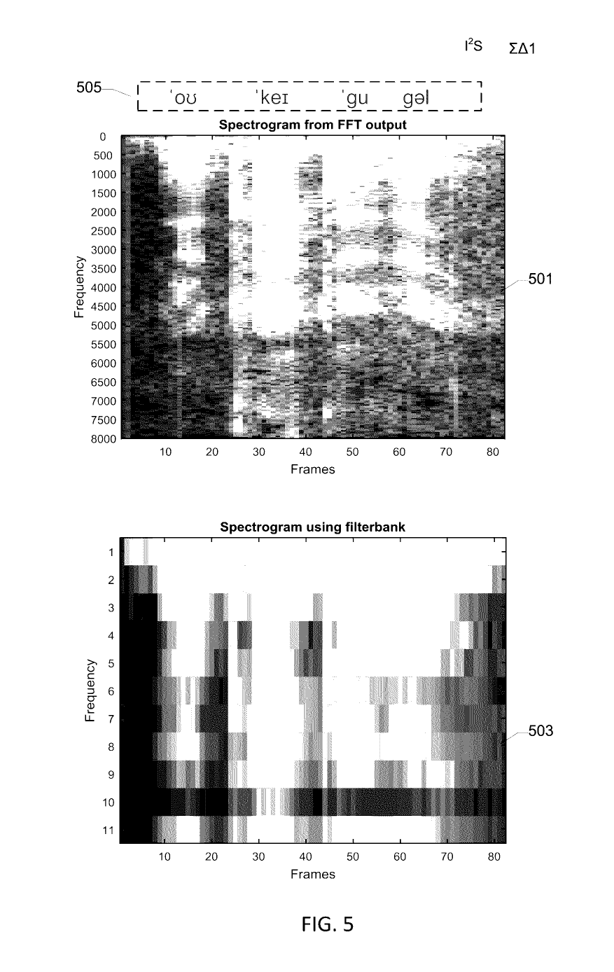

The upper spectrogram 501 of FIG. 5 shows the key phrase ‘OK Google’ plotted on a linear frequency scale spanning from 0 to 8 kHz. The x-axis depicts time in form of the previously discussed consecutive time frames of the multibit digital signal where each time frame corresponds to 10 ms such that the entire depicted length of the x-axis corresponds to about 850 ms (85 time frames). The spectrogram 501 is computed based on 256 bins FFT per time frame where the FFT is forming the previously discussed digital filter bank (item 301 of FIG. 1) and therefore possessing a good frequency resolution at least at high frequencies of the speech signal. However, the amount of computational power and memory required to generate such continuous spectrogram representations of the multibit digital signal (i.e. representing the microphone signal) is significant. The present embodiment of the invention uses the digital filter bank 301 with 11/7 adjacent frequency bands discussed with reference to FIGS. 2 and 3 above. This digital filter bank 301 leads to a markedly reduced power consumption compared to the FFT based digital filter bank. A corresponding spectrogram 503 of the key phrase ‘OK Google’ is shown on a semi-logarithmic frequency scale spanning from band 0 to band 11. The skilled person will appreciate that the frequency resolution of the 11/7 band digital filter bank is lower at low frequencies of the audio spectrum, but nevertheless sufficiently good to allow good discrimination of the predetermined sequence of individual phonemes defining the key phrase in question.

The predetermined sequence of individual phonemes for the key phrase ‘OK Google’= [symbol] is depicted above as the upper spectrogram 501 inside frame 505. In order to recognize the key phrase, the artificial neural network 400 has been trained by multiple speakers, for example pronouncing the key phrase multiple times such as 25 times, and the weights and neurons connections of the artificial neural network 400 are adjusted accordingly to form the sequence of phoneme expect patterns modelling the target or desired sequence of phonemes representing the key word or key phrase. In one embodiment of the artificial neural network 400, the neurons and connections are configured to recognize a single phoneme of the target sequence of phonemes at a time to save computational hardware resources as discussed below. The digital filter bank generates successive sets of normalized power/energy estimates of the frequency components 1-7 for each 10 ms time frame of the multibit digital signal. A current set of normalized power/energy estimates are stored in a FIFO buffer 401 of the artificial neural network 400 as indicated by buffer cells N1(n), N2(n), N3(n) etc. until N7(n) where index n indicates that the set of normalized power/energy estimates belongs to the frequency components of a current time frame. The FIFO buffer 401 also holds a plurality of sets of normalized power/energy estimates of frequency components belonging to the previous time frames of the multibit digital signal where cells N1(n−1), N2(n−1), N3(n−1) etc. illustrate individual normalized power/energy estimates of the time frame immediately preceding the time frame n. Likewise, cells N1(n−2), N2(n−2), N3(n−2) etc. illustrate individual normalized power/energy estimates of the time frame immediately preceding time frame n−1 and so forth for the total number of time frames represented in the FIFO buffer 401. One embodiment of the FIFO buffer 401 of the artificial neural network 400 may simultaneously store six sets of normalized power/energy estimates representing respective ones of six successive time frames (including the current time frame) of the multibit digital signal corresponding to a 60 ms segment of the multibit digital signal. The FIFO buffer 401 shows only the three-four most recent time frames frame n, n−1 and n−2 for simplicity. The six sets of normalized power/energy estimates held in the FIFO buffer 401, i.e. total of 6*7=42 normalized power/energy estimates for the present embodiment, are applied to a corresponding number of input cell or memory elements 403 of the artificial neural network 400. The memory elements 403 may comprise flip-flops, RAM cells, register files etc. These six sets of normalized power/energy estimates are compared with a first phoneme expect pattern modelling the first phoneme ‘oυ’ of the target phrase.

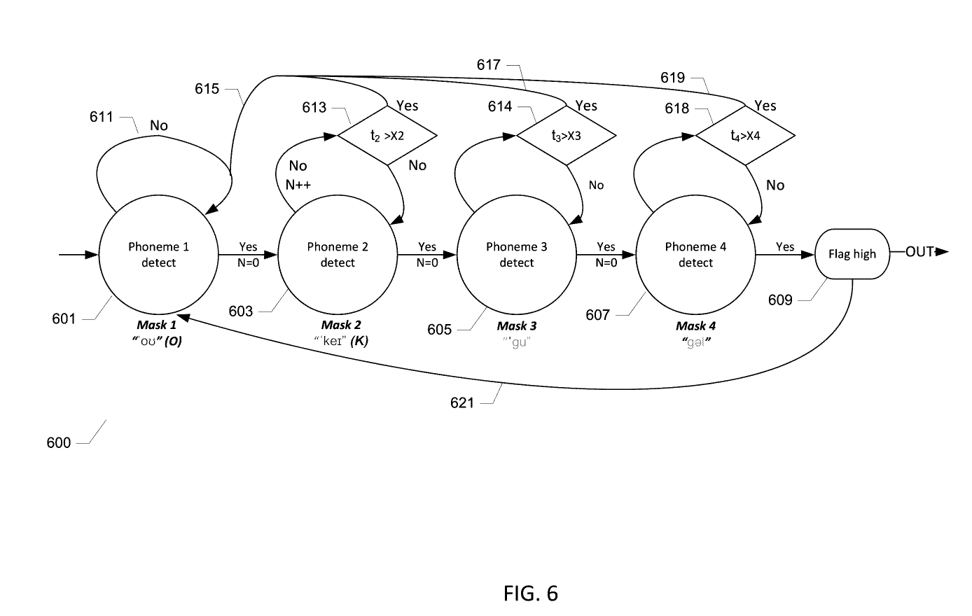

This first phoneme expect pattern is loaded into the artificial neural network 400 during initialization of the key word recognizer 110 of the artificial neural network 400. Due to the operation of the FIFO buffer 401, a new set of normalized power/energy estimates of the frequency components, corresponding to a new 10 ms time frame, of the multibit digital signal is regularly loaded into the FIFO buffer 401 while the oldest set of normalized power/energy estimates is discarded. Thereby, the artificial neural network 400 will repeatedly compare the first phoneme expect pattern (‘oυ’) with the successive sets of frequency components, as represented by the respective sets of normalized power/energy estimates, held in the FIFO buffer 401. Once a current sample of the six sets of normalized power/energy estimates N1(n), N2(n), N3(n) etc. held in the memory elements 403 matches the first phoneme expect pattern, the output, OUT, of the artificial neural network 400 changes state so as to flag or indicate the detection of the first phoneme expect pattern. Once, the first phoneme has been detected, the key word recognizer 110 proceeds to skip the current, i.e. still first, phoneme expect pattern and load a second phoneme expect pattern into the artificial neural network 400. This may be accomplished by adjusting, or loading new weights into the network 400 and reconfigure the respective connections between weights and the neurons. The second phoneme expect pattern corresponds to the second phoneme 'kei of the target phoneme sequence. The switch between the different phoneme expect patterns associated with the target key word is carried out by a digital processor. The digital processor of the present embodiment uses a state machine 600 (refer to FIG. 6), but the skilled person will appreciate that the digital processor of alternative embodiments of the key word recognizer may comprise a software programmable microprocessor. Hence, once the first phoneme has been detected, the hardware resources of the artificial neural network 400 are reused or reconfigured for recognizing the second phoneme. This is a significant advantage of the present embodiment in power consumption and space constrained applications such as the present processing circuit 105 of the microphone assembly 100.

FIG. 6 shows an exemplary embodiment of the state machine 600 of the key word recognizer 110. The state machine 600 comprises four internal states 601, 603, 605, 607 corresponding to the four individual expect phoneme patterns of the sequence of phonemes [symbol] representing the key phrase. The respective phoneme expect patterns or masks associated with the four internal states 601, 603, 605, 607 are illustrated as Mask 1-4 below the internal state symbols 601, 603, 605, 607. During operation of the network, the state machine 600 resides in the first internal state 601 monitoring the microphone signal as illustrated by the “No” repetition arrow 611 until the first phoneme has been detected in the incoming microphone signal. In response to the detection of the first phoneme, the state machine 600 proceeds to the second internal state 603 as illustrated by the “Yes” arrow exiting the first state 601. The state machine 600 thereafter resides in the second internal state 603 monitoring the incoming microphone signal for the second phoneme 'kei as illustrated by the “No” repetition arrow until the second phoneme is detected in the incoming microphone signal. In response to detection of the second phoneme within the incoming microphone signal, the state machine 600 proceeds to the third internal state 605 as illustrated by the “Yes” arrow leading out of the second state 603. However, the state machine 600 may further add a time constraint or time window for the detection of the second phoneme during the second internal state 603 as illustrated by comparison box 613. This time window is helpful to ignore false/unrelated detections of the second phoneme under conditions where a time delay between the first phoneme detection and the second phoneme detection is too long to make the phonemes part of the same key word or key phrase. For example if this time delay is larger than one second or several seconds it suggests that the occurrence of the second phoneme is made in another context than the pronunciation of the key phrase or word. In other words, the time constraint or time window ensures the existence of an appropriate timing relationship between the occurrence of the first and second phonemes, or any other pair of successive phonemes of the key phrase, consistent with normal human speech production. Therefore, verifying or ensuring that the pair of successive phonemes really is part of the same key word or phrase. The length of the time window associated with the second internal state 603 is X2 as indicated inside comparison box 613. The length of X2 may be less than 500 ms such as less than 300 ms measured from the detection of the first phoneme. Hence, the state machine 600 may be configured to reside in the second internal state 603 at the most for the 500 ms time window, e.g. between 0 ms and 500 ms. If the duration, t₂, of the second internal state 603 exceeds 500 ms, the result of the time window test carried out in comparison box 613 becomes yes and the state machine reverts or jumps to the first internal state 601 as illustrated by arrow 615. On the other hand, if the second phoneme is detected within the time window t₂, the state machine 600 proceeds to the third internal state 605 as mentioned above. The state machine 600 thereafter resides in the third internal state 605 monitoring the incoming microphone signal for the third phoneme 'gu as illustrated by the “No” repetition arrow until either the third phoneme is detected or a second time window constraint, t₃, operating similar to time window constraint discussed above expires. The length of the second time window, t₃, associated with the third internal state 605 may be similar to the length of the time window t₂ of the second state discussed above, or it may be different depending on the language specifics of the sought after key phrase or key word. Hence, the state machine 600 may be configured to reside in the third internal state 605 for at the most the duration of the second time window t₃ and revert to the first internal state 601 if the third phoneme remains undetected within the second time window t₃ as illustrated by arrow 617. In contrast if the third phoneme is detected within the second time window, the state machine 600 in response proceeds to the fourth internal state 607 as illustrated by the “Yes” arrow leading out of the third state 605.

The state machine 600 thereafter resides in the fourth internal state 607 for a maximum period corresponding to a third time window t₄ monitoring the incoming microphone signal for the fourth phoneme “gal” as illustrated by the “No” repetition arrow circling through comparison box 618 until either the fourth phoneme is detected or the third time window expires in a similar manner to the third internal state discussed above. If the fourth phoneme remains undetected within the third time window t₄, the state machine 600 reverts or jumps in response to the first internal state 601 as illustrated by arrow 619. Alternatively, if the fourth phoneme is detected within the third time window t₄, the state machine 600 determines that the sought after sequence of the four individual phonemes [symbol] representing the key phrase has been detected. In response, the state machine 600 proceeds to raise the detection flag or indication in step 609 at terminal OUT and thereby signalling the detection of the key phrase. Thereafter, the state machine 600 jumps back to the first internal state 601 once again monitoring the incoming microphone signal and awaiting the next occurrence of the key phrase as illustrated by arrow 621.

The skilled person will understand that the above-described operation of the state machine 600 leads to a reduced risk of false positive detection events of the key word or key phrase because the state machine monitors and evaluates the time relationships between the individual phonemes representing the key word or phrase and skips the sequence if a particular phoneme is missing in the sequence or has an odd time relationship with a preceding phoneme. In the latter situation, the state machine 600 skips the currently detected sequence of phonemes and reverts to the first internal state monitoring the incoming microphone signal for a valid occurrence of the key word or phrase. This reduced risk of false positive detection events of the key word or key phrase is a significant advantage of the present microphone assembly because it reduces the number of times the host processor is triggered by false key word/phrase detection events. Each such false detection event typically leads to significant power consumption in the host processor because asserting the detection flag typically forces the host processor to switch from the previously discussed sleep-mode or low-power mode of operation to an operational mode for example via an interrupt routine running on the host processor.

The skilled person will understand that other embodiments of the key word recognizer 110 may require only a subset of the individual phonemes, e.g. three of the above-discussed four phoneme, representing the key word or phrase be correctly detected before the detection of the key word is flagged. This alternative mechanism may increase the success rate of correct detections of the key word because of accidentally overlooking a single phoneme of the sequence. On the other hand, this entails a risk of triggering a false positive key word detection event.

FIG. 7 shows a first embodiment of the FIFO or circular buffer 112 described above in connection with FIG. 1. The FIFO buffer 112 is configured to temporarily store running time segments of the multibit digital signal for example time segments corresponding to 500 ms of the incoming microphone signal. The multibit digital signal generated by the A/D converter may be sampled at 16 kHz with a resolution between 12 and 24 bits. The FIFO buffer 112 comprises an encoder which formats or otherwise encodes the incoming samples of the multibit digital signal representing the microphone signal. A FIFO controller continuously writes the incoming samples of the multibit digital signal to appropriate memory addresses of the buffer memory ensuring that the FIFO buffer always stores the most recent time segment of the digital multibit signal by overwriting the oldest samples and adding current samples of the multibit digital signal to the buffer memory. The decoder reformats audio samples stored in the FIFO buffer 112 to the format of the multibit digital signal when the time segment held in the buffer memory is transmitted out of the buffer. The FIFO buffer 112 may be emptied in response to the detention of the key word or phrase by the key word recognizer discussed above. The FIFO controller may respond to the detection flag or indication and begin emptying the buffer memory. A burst mode switch controls which audio samples of the multibit digital signal that are transmitted to the output, OUT, of the FIFO buffer 112. Since, the audio samples held in the buffer memory represents past time, the audio samples held in the buffer memory are initially outputted via bus 703 by the burst mode switch. Once the memory of the FIFO buffer is empty, the burst mode switches to convey current audio samples, i.e. current multibit digital signal, via bus 701. The current audio samples are transmitted directly from the output of the A/D converter to the output of the FIFO buffer 112. In this manner, in response to key word detection a time segment comprising the most recent 500 ms of audio samples are initially transmitted out of the memory of the FIFO buffer 112 and through the PDM or PCM audio interface 114 to the external host processor. Thereafter, the audio samples of the buffer and the current audio samples are seamlessly spliced by the burst mode switch resulting in a continuous transmission of audio samples representing the incoming microphone signal to the external host processor once the key word has been detected or recognized. The burst mode switch may increase the speed at which the audio samples held in the FIFO buffer 112 are transmitted through the PDM or PCM audio interface 114 relative to a real-time speed of the audio samples such that the host processor is able to catch-up with real-time audio samples derived from the incoming microphone signal.

FIG. 7 additionally illustrates a second embodiment 712 of the FIFO or circular buffer described above in connection with FIG. 1. The input and output data interfaces, at Audio input and OUT, of the second FIFO buffer 712 are overall similar to those of the first FIFO buffer 112 discussed above. However, the size, in form of semiconductor die area, of the second FIFO buffer 712 is approximately halved compared to the first FIFO buffer 112 for a given time segment length of the multibit digital signal, via the operation of a few further signal processing functions. The reduction of semiconductor die area, or a corresponding increase of the length of the time segment of the multibit digital signal, has been achieved by a reduction, e.g. a halving, of the sampling frequency of the multibit digital signal before storage in memory cells of the second FIFO buffer 712. The multibit digital signal generated by the A/D converter at the input, Audio, of buffer 712 has typically a sampling frequency of 16 kHz as previously discussed. A down-sampling circuit or decimator 710 of the second FIFO buffer 712 converts the multibit digital signal from this 16 kHz sampling frequency to a 8 kHz sampling frequency. This down-sampling operation preferably includes a lowpass filtering at about 4 kHz to suppress the introduction of aliasing components to the multibit digital signal at the reduced sampling frequency. When the data buffer of the second FIFO buffer 712 is emptied through a burst mode switch 717, the stored segment of the multibit digital signal is up-sampled by an upsampler 714 to the original 16 kHz sampling frequency before application to the burst mode switch 717. In this manner, the sampling frequency of the stored segment of the multibit digital signal matches the sampling frequency of the current or real-time multibit digital signal supplied by the A/D converter output. The second FIFO buffer 712 may comprise a filter for example an all-pass filter 715 inserted in the direct signal path extending the input, Audio, of FIFI buffer 712 to the burst mode switch 717. The filter 715 is configured to compensate for the time delay and other possible phase shifts caused by filtering in the decimator 710 and up-sampler 714. The filter 715 is thereby able to suppress or reduce audible clicks or pops generated by the burst mode switch 717 in connection with a switch from transmitting the stored multibit digital signal from the buffer memory to transmitting the real-time multibit digital signal to the output OUT. The burst mode switch 717 may furthermore include a suitable fading mechanism between the two multibit digital signals to further reduce any audible clicks or pops.

The skilled person will appreciate that the audio bandwidth of the stored multibit digital signal in the buffer memory is reduced for example to approximately one-half of the original audio bandwidth. This reduced audio bandwidth exists, however, only for the duration of the multibit digital signal held in the buffer memory which may be around 500-800 ms. The multibit digital signal held in the buffer memory comprises inter alia the recognized key word or key phrase (e.g. like “OK Google”) when it is emptied and this key word or key phrase will usually not include any significant amount of high frequency content. Hence, this short moment of reduced audio bandwidth of the multibit digital signal may go essentially unnoticed.

1. A microphone assembly comprising:
a transducer element configured to convert sound into a microphone signal,
a housing supporting the transducer element and a processing circuit, said processing circuit comprising:
an analog-to-digital converter configured to receive, sample and quantize the microphone signal to generate a multibit or single-bit digital signal;
a phoneme recognizer comprising:
a digital filterbank comprising a plurality of adjacent frequency bands and being configured to divide successive time frames of the multibit or single-bit digital signal into corresponding sets of frequency components;
an artificial neural network (ANN) comprising at least one phoneme expect pattern,
a digital processor configured to repeatedly applying the one or more sets of frequency components derived from the digital filter bank to respective inputs of an artificial neural network,
where the artificial neural network is further configured to comparing the at least one phoneme expect pattern with the one or more sets of frequency components to detect and indicate a match between the at least one phoneme expect pattern and the one or more sets of frequency components.

2. A microphone assembly according to claim 1, wherein the artificial neural network comprises:
a plurality of input memory cells, at least one output neuron and a plurality of internal weights disposed in-between the plurality of input memory cells and the least one output neuron; and
the plurality of internal weights are configured or trained for representing the at least one phoneme expect pattern.

3. A microphone assembly according to claim 2, wherein the artificial neural network comprises 128 or less internal weights in a trained state representing the at least one phoneme expect pattern.

4. A microphone assembly according to claim 2, wherein the phoneme recognizer comprises:
a plurality of further memory cells for storage of respective phoneme configuration data for the artificial neural network for a predetermined sequence of phoneme expect patterns modelling a predetermined sequence of phonemes representing a key word or key phrase;
the digital processor being configured to, in response to the detection of the first phoneme expect pattern:
sequentially comparing the phoneme expect patterns of the predetermined sequence of phoneme expect patterns with the one or more sets of frequency components using the respective phoneme configuration data in the artificial neural network to determine respective matches until a final phoneme expect pattern of the sequence of phoneme expect patterns is reached,
in response to a match between a final phoneme expect pattern of the predetermined sequence of phoneme expect patterns and the one or more sets of frequency components, indicating a detection of the key word or key phrase.

5. A microphone assembly according to claim 4, wherein the digital processor is further configured to:
switching between two different phoneme expect patterns of the predetermined sequence of phoneme expect patterns by replacing a set of internal weights of the artificial neural network representing a first phoneme expect pattern with a new set of internal weights representing a second phoneme expect pattern; and
replacing connections between the set of internal weights and the at least one neuron representing the first phoneme expect pattern with connections between the set of internal weights and the at least one neuron representing the second phoneme expect pattern.

6. A microphone assembly according to claim 1, wherein the digital processor is further configured to:
limiting the comparison between each phoneme expect pattern of the sequence of further phoneme expect patterns and the one or more sets of frequency components to a predetermined time window;
in response to a match, within the predetermined time window, between the phoneme expect pattern and the one or more set of frequency components, proceeding to a subsequent phoneme expect pattern of the sequence; and
in response to a lacking match, within the predetermined time window, between the phoneme expect pattern and the one or more sets of frequency components, reverting to comparing the first phoneme expect pattern with the one or more sets of frequency components.

7. A microphone assembly according to claim 6, wherein the duration of the predetermined time window is less than 500 ms for at least one phoneme expect pattern of the sequence of further phoneme expect patterns.

8. A microphone assembly according to claim 1, wherein each of the successive time segments of the multibit or single-bit digital signal represents a time period of the microphone signal between 5 ms and 50 ms such as between 10 and 20 ms.

9. A microphone assembly according to claim 1, wherein each frequency component of the one or more sets of frequency components is represented by an average amplitude, average power or average energy.

10. A microphone assembly according to claim 1, wherein the digital filterbank comprises between 5 and 20 overlapping or non-overlapping frequency bands to generate corresponding sets of frequency components having between 5 and 20 individual frequency components for each time frame.

11. A microphone assembly according to claim 1, wherein the key word recognizer comprises a buffer memory, such as a FIFO buffer, for temporarily storing between 2 and 20 sets of frequency components derived from corresponding time frames of the multibit or single-bit digital signal.

12. A microphone assembly according to claim 1, wherein the digital processor comprises a state machine comprising a plurality of internal states where each internal state corresponds to a particular phoneme expect pattern of the predetermined sequence of phoneme expect patterns.

13. A microphone assembly according to claim 1, wherein the analog-to-digital converter configured comprises a sigma-delta modulator followed by a decimator to provide the multibit (PCM) digital signal.

14. A microphone assembly according to claim 1, wherein the processing circuit comprises an externally accessible command and control interface such as I²C, USB, UART or SPI, for receipt of configuration data of the artificial neural network and/or configuration data of the digital filter bank.

15. A microphone assembly according to claim 1, the processing circuit comprises an externally accessible terminal for supplying an electrical signal indicating the detection of the key word or key phrase.

16. A microphone assembly according to claim 1, wherein the housing surrounds and encloses the transducer element and the processing circuit, said housing comprising sound inlet or sound port conveying sound waves to transducer element.

17. A semiconductor die comprising a processing circuit according to claim 1.

18. A portable communication device comprising a transducer assembly according to claim 1.

19. A method of detecting at least one phoneme of a key word or key phrase in a microphone assembly, said method comprising:
a) converting incoming sound on the microphone assembly into a corresponding microphone signal;
b) sampling and quantizing the microphone signal to generate a multibit or single-bit digital signal representative of the microphone signal;
c) dividing successive time frames of the multibit or single-bit digital signal into corresponding sets of frequency components through a plurality of frequency bands of a digital filter bank;
d) loading configuration data of at least one phoneme expect pattern into the artificial neural network;
e) applying one or more sets of the frequency components generated by the digital filter bank to inputs of the artificial neural network to detect a match;
f) indicating the match between the at least one phoneme expect pattern and the one or more sets of frequency components at an output of the artificial neural network.

20. A method of detecting phonemes according to claim 19, further comprising:
g) loading into a plurality of memory cells of a processing circuit of the assembly, respective phoneme configuration data of a predetermined sequence of phoneme expect patterns modelling a predetermined sequence of phonemes representing the key word or key phrase, where the at least one phoneme expect pattern forms a first expect pattern of the predetermined sequence of phoneme expect patterns;
h) applying the one or more sets of the frequency components generated by the digital filter bank to inputs of the artificial neural network to detect a match between the first phoneme expect pattern and the one or more sets of frequency components;
i) in response to the detection of the first phoneme, loading a subsequent set of phoneme configuration data into the artificial neural network representing a subsequent phoneme expect pattern to the first phoneme expect pattern;
j) applying the one or more sets of frequency components to the inputs of the artificial neural network to determine a match to the subsequent phoneme expect pattern;
k) repeating steps i) and j) until a final phoneme expect pattern of the predetermined sequence of phoneme expect patterns is reached;
l) indicating a detection of the key word or key phrase in response to a match between the final phoneme expect pattern and the one or more sets of frequency components.

21. A method of detecting phonemes according to claim 20, further comprising:
m) in response to a missing match between the subsequent phoneme expect pattern and the one or more sets of frequency components within a time window, jumping to step h);
n) in response to a match between the subsequent phoneme expect pattern and the one or more sets of frequency components within the time window, jumping to step j).

22. A method of detecting phonemes according to claim 20, wherein step i) further comprises overwriting current internal weights and current connections between the internal weights and the at least one neuron representing a current phoneme expect pattern with new internal weights and new connections between the internal weights and the at least one neuron representing a subsequent phoneme expect pattern.
